(19) United States
(12) Patent Application Publication
(10) Pub. No.: US 2025/0016891 A1
(43) Pub. Date: Jan. 9, 2025

(54) VEHICLE EXTERIOR COMPONENT

(71) Applicant: TOYODA GOSEI CO., LTD., Kiyosu-shi (JP)

(72) Inventors: Koji FUKAGAWA, Kiyosu-shi (JP); Tatsuya MATSUI, Kiyosu-shi (JP); Moriyuki HASHIMOTO, Kiyosu-shi (JP); Koji OKUMURA, Kiyosu-shi (JP)

(21) Appl. No.: 18/756,792

(22) Filed: Jun. 27, 2024

(30) Foreign Application Priority Data
Jul. 5, 2023 (JP) 2023-110714

(51) Int. Cl. H05B 3/28; B60R 13/00; B60R 16/02; H05B 3/86

(52) U.S. Cl. CPC H05B 3/286; B60R 16/02; H05B 3/86; B60R 13/005; H05B 2203/016

(57) ABSTRACT

A vehicle exterior component includes a plate-shaped main body and a heater sheet and a connector that are arranged on the main body. The heater sheet includes a sheet base and a heater wire including two terminals. The heater wire includes a part excluding the two terminals that is laid out on the sheet base at a side closer to the main body. The connector includes a connector housing and two connector pins fixed to the connector housing. Each connector pin includes a first connecting portion and a second connecting portion electrically connected to one of the terminals of the heater wire outside the connector housing. The heater wire includes a part that is laid out on the sheet base so that 50% or greater of the heater wire in a thickness direction of the main body is embedded in the sheet base.

### CROSS-REFERENCE TO RELATED APPLICATIONS

This application is based upon and claims the benefit of priority from prior Japanese Patent Application No. 2023-110714, filed on Jul. 5, 2023, the entire contents of which are incorporated herein by reference.

### BACKGROUND

### 1. Field

The present disclosure relates to a vehicle exterior component.

### 2. DESCRIPTION OF RELATED ART

A vehicle exterior component, such as an emblem arranged on the front end of the vehicle, may be provided with a defrosting functionality (for example, refer to Japanese Patent No. 6719506).

FIGS. 11 and 12 show one example of such a vehicle exterior component that includes a plate-shaped main body 100, a heater sheet 102, and a connector 106. The main body 100 is plate-shaped and formed by a plastic molded article. The heater sheet 102 and the connector 106 are arranged on the main body 100. The heater sheet 102 includes a sheet base 103 and a heater wire 104. The sheet base 103 is arranged on the main body 100. The heater wire 104 is heated when energized and includes two ends defining two terminals 105. The part of the heater wire 104 excluding the two terminals 105 is laid out on the sheet base 103 at the side closer to the body 100. The part of the heater wire 104 laid out on the sheet base 103 is exposed on the surface of the sheet base 103 at the side closer to the main body 100.

The connector 106 includes a connector housing 107, which is fixed to the main body 100, and two connector pins 108, which are fixed to at least the connector housing 107. The connector housing 107 projects from the main body 100 toward one side in a thickness direction of the main body 100. Each connector pin 108 includes a first connecting portion 111, which is coupled to a power supplying device, and a second connecting portion 112, which is continuous with the first connecting portion 111 and electrically connected to a corresponding one of the terminals 105 outside the connector housing 107.

The connector housing 107 includes end surfaces 107a at opposite sides in a direction orthogonal to the thickness direction (hereinafter, simply referred to as the orthogonal direction). Each second connecting portion 112 has an end 112a at the side farther from the first connecting portion 111. The end 112a is located between the end faces 107a. The sheet base 103 is separated from the connector housing 107 in the orthogonal direction. Each terminal 105 extends from the sheet base 103 in the orthogonal direction and is electrically connected to the corresponding second connecting portion 112.

The main body 100 includes a support 101 that supports the connector housing 107. The end of the connector housing 107 closer to the main body 100 is referred to as a basal end 107b. The support 101 is located in a region Z1 that extends around the connector housing 107 and includes at least the basal end 107b in the projecting direction of the connector housing 107. The support 101 is adjacent to the connector housing 107 and extends along the connector housing 107 in the projecting direction of the connector housing 107.

FIG. 11 shows the positional relationship of the connector 106 and the two terminals 105. FIG. 11 does not show the main body 100 and the sheet base 103.

The vehicle exterior part is manufactured by insert-molding the main body 100 with the connector 106 and the heater sheet 102 included as inserts.

Breakage of the heater wire 104 may occur in the vehicle exterior component. For example, when the body 100 is insert-molded, the flow pressure (molding pressure) of the molten plastic injected into a mold cavity will apply shear force to the heater wire 104. The shear force may deform and break the heater wire 104 at a part where the heater wire 104 is not supported by the sheet base 103, the connector housing 107, or the connector pin 108. The part of the sheet base 103 that is exposed is also susceptible to such breakage.

Further, the shear force may produce excess load that acts on the heater wire 104 at the boundary between the part where the heater wire 104 is in contact with the sheet base 103 and the part where the heater wire 104 is not in contact with the sheet base 103. In the same manner, the shear force may also produce excess load that acts on the heater wire 104 at the boundary between the part where the heater wire 104 is in contact with the connector housing 107 and the part where the heater wire 104 is not in contact with the connector housing 10. Additionally, the shear force may produce excess load that acts on the heater wire 104 at the boundary between the part where the heater wire 104 is in contact with the second connecting portion 112 and the part where the heater wire 104 is not in contact with the second connecting portion 112. Such excess loads may cause heater wire breakage.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle exterior component includes a main body that is plate-shaped and formed by a plastic molded article, and a heater sheet and a connector that are arranged on the main body. The heater sheet includes a sheet base arranged on the main body, and a heater wire configured to be heated when energized and including two ends defining two terminals. The heater wire includes a part excluding the two terminals that is laid out on the sheet base at a side closer to the main body. The connector includes a connector housing fixed to the main body, and two connector pins fixed to the connector housing. Each of the connector pins includes a first connecting portion configured to be coupled to a power supplying device, and a second connecting portion electrically connected to a corresponding one of the terminals of the heater wire outside the connector housing. The heater wire includes a part that is laid out on the sheet base so that 50% or greater of the heater wire in a thickness direction of the main body is embedded in the sheet base.

In another general aspect, a vehicle exterior component includes a main body that is plate-shaped and formed by a plastic molded article, and a heater sheet and a connector that are arranged on the main body. The heater sheet includes a sheet base arranged on the main body, and a heater wire configured to be heated when energized and including two ends defining two terminals. The heater wire includes a part excluding the two terminals that is laid out on the sheet base at a side closer to the main body. The connector includes a connector housing fixed to the main body, and two connector pins fixed to the connector housing. Each of the connector pins includes a first connecting portion configured to be coupled to a power supplying device, and a second connecting portion electrically connected to a corresponding one of the terminals of the heater wire outside the connector housing. The second connecting portion of each of the connector pins includes an extension that extends away from the connector housing in a direction orthogonal to the thickness direction. The sheet base and each of the terminals extend to where the main body is located at an opposite side of the extension in the thickness direction. The extension includes a groove extending toward the first connecting portion from an end surface of the extension that is farther from the first connecting portion. The groove is open in a surface of the extension that is closer to the sheet member in the thickness direction.

Other features and aspects will be apparent from the following detailed description, the drawings, and the claims.

### BRIEF DESCRIPTION OF THE DRAWINGS

FIG. 1 is a cross-sectional view showing part of a millimeter wave transmissive cover, which is a first embodiment of a vehicle exterior component, together with a millimeter wave radar device.

FIG. 2 is an enlarged cross-sectional view showing part of the millimeter wave transmissive cover of FIG. 1.

FIG. 3 is a perspective view of a heater sheet in the first embodiment.

FIG. 4 is a cross-sectional view taken along line 4-4 in FIG. 2.

FIG. 5 is a partial rear view showing a heater wire in a state joined with a connector pin in the first embodiment.

FIG. 6 is a rear view of the connector pin in the first embodiment.

FIG. 7 is a cross-sectional view taken along line 7-7 in FIG. 6.

FIG. 8 is a cross-sectional view showing part of the millimeter wave transmissive cover in a case where the connector pin does not include a groove.

FIG. 9 is a cross-sectional view illustrating a process for insert-molding a main body with a molding device in the first embodiment.

FIG. 10 is a cross-sectional view showing part of a millimeter wave transmissive cover, which is a second embodiment of a vehicle exterior component.

FIG. 11 is a perspective view showing a connector and two terminals of a heater wire in a vehicle exterior component of the related art.

FIG. 12 is a cross-sectional view showing the vehicle exterior component of the related art.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

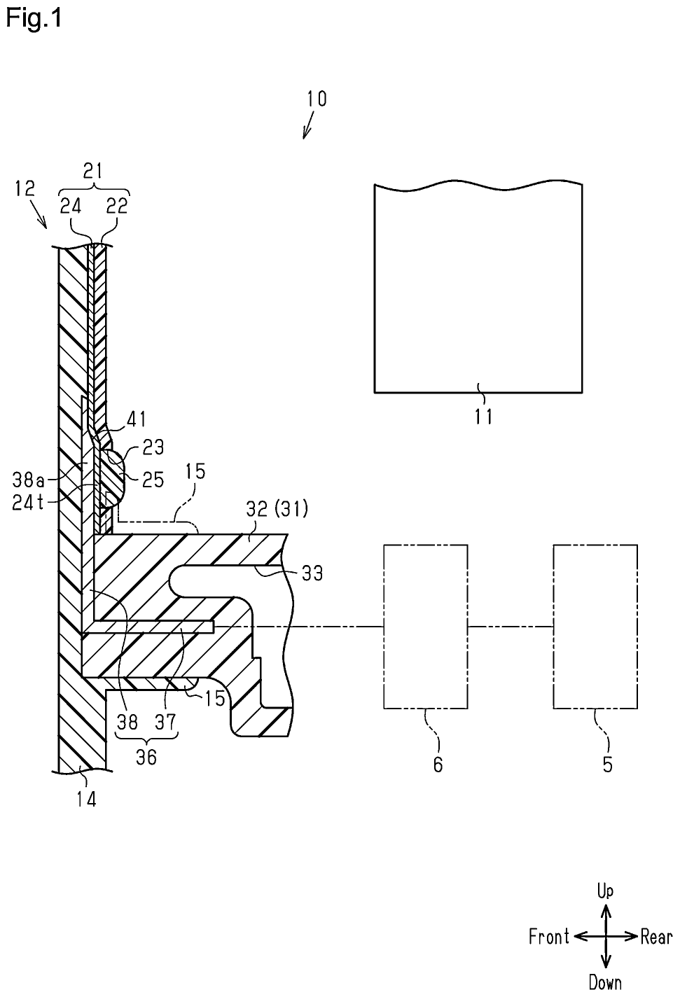

A millimeter wave transmission cover, which is a first embodiment of a vehicle exterior transmissive cover, will now be described with reference to FIGS. 1 to 9.

In the description hereafter, the front direction will correspond to the forward direction of a vehicle 10, and the rear direction will correspond to the rearward direction of the vehicle 10. The vertical direction will correspond to the upward and downward directions of the vehicle 10. The left and right directions will correspond to the transverse direction, or the leftward and rightward directions when the vehicle 10 moves forward. The drawings are illustrated in different scales to clarify each part of a millimeter wave transmissive cover 12.

As shown in FIG. 1, a millimeter wave radar device 11 for front monitoring is arranged on the front middle part of the vehicle 10 and used as a sensor device that transmits and receives electromagnetic waves to detect objects outside the vehicle 10. The millimeter wave radar device 11 transmits millimeter waves, which are included in electromagnetic waves, toward the front of the vehicle 10 and receives the millimeter waves reflected by an object outside the vehicle 10.

As described above, the millimeter wave radar device 11 transmits millimeter waves toward the front of the vehicle 10. Thus, the direction in which the millimeter wave radar device 11 transmits the millimeter waves is the direction extending from the rear to the front of the vehicle 10. The front side with respect to the millimeter wave transmission direction substantially corresponds to the forward direction of the vehicle 10. The rear side with respect to the millimeter wave transmission direction substantially corresponds to the rearward direction of the vehicle 10. Thus, in the description hereafter, the front side with respect to the millimeter wave transmission direction will simply be expressed by terms such as front and forward. Further, the rear side with respect to the millimeter wave transmission direction will simply be expressed by terms such as rear and rearward.

The millimeter wave transmissive cover 12 is arranged in front of the millimeter wave radar device 11. The millimeter wave transmissive cover 12 is held upright so that its front surface faces the forward direction of the vehicle 10 and its rear surface faces the rearward direction of the vehicle 10.

The millimeter wave transmissive cover 12 includes a main body 14, which is formed by a plastic molded article, and a heater sheet 21 and a connector 31, which are arranged on the main body 14. The elements and basic structure of the millimeter wave transmissive cover 12 will now be described.

### Main Body 14

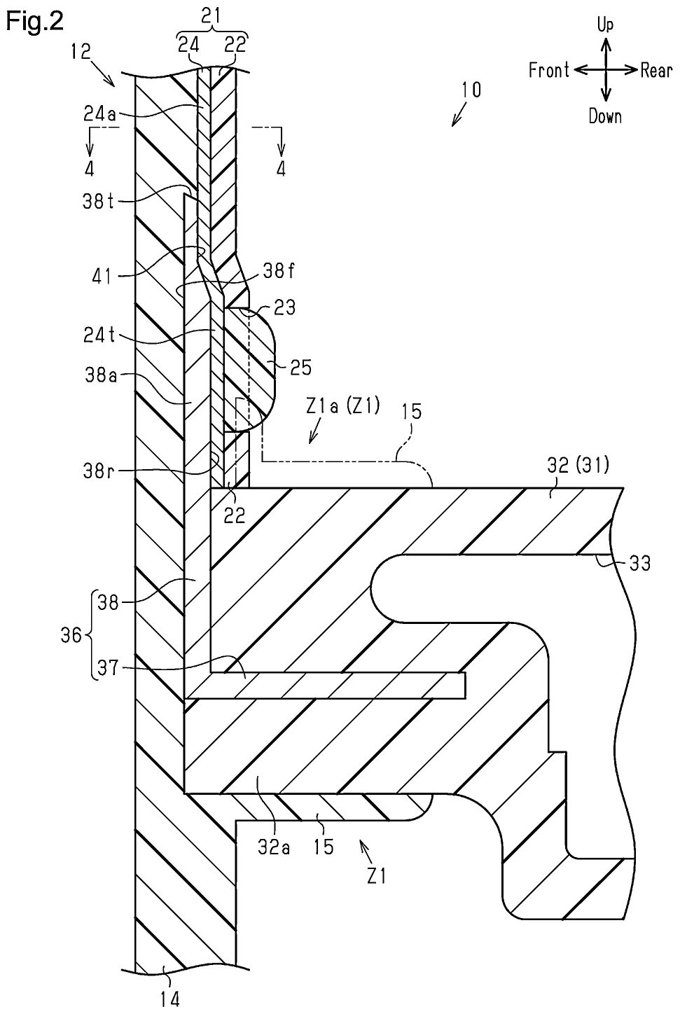

Referring to FIG. 2, the main body 14 is millimeter wave transmissive. The main body 14 is molded from a plastic material into the form of a plate. The millimeter wave transmissive cover 12 is attached to the vehicle 10 so that its front-rear direction corresponds to the thickness direction of the main body 14. In the first embodiment, the thickness direction of the main body 14 corresponds to the front-rear direction.

Examples of the plastic material forming the main body 14 include polypropylene (PP), polycarbonate (PC), acrylonitrile ethylene styrene (ABS), acrylonitrile ethylene styrene (AES), and the like. Other examples include poly(methyl methacrylate) (PMMA), acrylonitrile styrene acrylate (ASA), and PMMA containing ASA. In the first embodiment, the main body 14 is formed from ABS.

### Heater Sheet 21

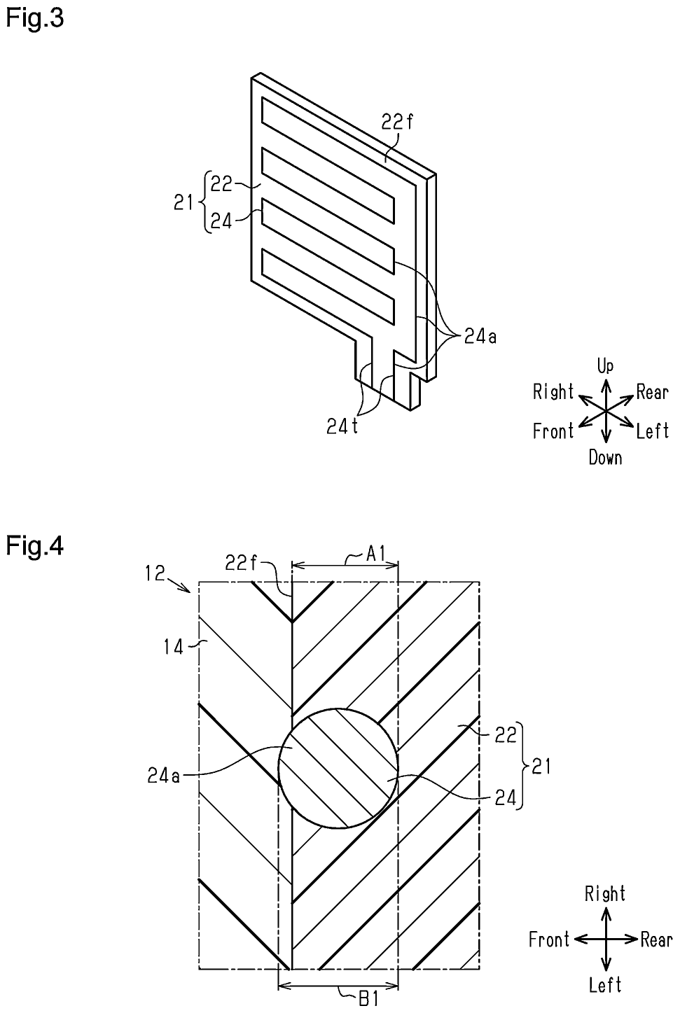

As shown in FIGS. 2 and 3, the heater sheet 21 includes a sheet base 22, which is millimeter wave transmissive, and a heater wire 24, which is energized to generate heat.

The sheet base 22 is plate-shaped and formed from a plastic material. The sheet base 22 may be formed from the same plastic material as the main body 14. This increases adhesion between the sheet base 22 and the main body 14. When the sheet base 22 is formed from ABS in the same manner as the main body 14, the saturated water absorption of the sheet base 22 will decrease. This limits expansion of the sheet base 22 in its thickness direction that would be caused by the moisture contained in the sheet base 22. Thus, the millimeter wave transmittance of the sheet base 22 can be maintained.

The sheet base 22 is arranged on the main body 14 in a region that transmits millimeter waves at one side (rear side) of the main body 14 in the thickness direction. The sheet base 22 is in contact with the main body 14.

The heater wire 24 is formed by a resistance wire, which is a conductive wire such as a nichrome wire that generally has a high electrical resistance. The heater wire 24 has a circular cross section (refer to FIG. 4). The heater wire 24 includes two ends defining two terminals 24t. In the first embodiment, the two terminals 24t are located at the lowermost part of the heater wire 24 and extend in the vertical direction.

In the first embodiment, the heater wire 24 is entirely laid out on the side of the sheet base 22 that is closer to the main body 14 in the thickness direction. The heater wire 24 includes a part excluding the two terminals 24t that is laid out in a predetermined wiring pattern. The wiring pattern is not particularly limited and may include, for example, parallel straight sections and connecting sections, which connect adjacent straight sections.

### Connector 31

As shown in FIG. 2, the connector 31 includes a connector housing 32, which is fixed to the main body 14, and two connector pins 36 (only one shown in FIGS. 1 and 2), which are fixed to the connector housing 32.

### Connector Housing 32

The connector housing 32 is formed from an electrically insulative material, for example, AES (alkaline earth silicate) or the like.

The connector housing 32 is arranged on the main body 14, for example, outside the region that transmits millimeter waves at the rear side of the main body 14. In the first embodiment, the connector housing 32 is arranged downward from the two terminals 24t of the heater wire 24.

The connector housing 32 projects from the main body 14 in the thickness direction, that is, in the rearward direction. The connector housing 32 has a rear surface including a recess 33 that is recessed toward the front.

Instead of AES, the connector housing 32 may be formed from ASA plastic, PC, a polymer alloy of PC and ABS, or the like.

### Connector Pins 36

With reference to FIGS. 2 and 6, the two connector pins 36 are formed from a conductive material, such as metal, and are identical in shape. Each connector pin 36 includes a first connecting portion 37, which is plate-shaped and extends rearward from the front end of the connector housing 32, and a second connecting portion 38, which extends from the front end of the first connecting portion 37. In each connector pin 36, the first connecting portion 37 is continuous with the second connecting portion 38. Each connector pin 36 is L-shaped. The connector pins 36 are, for example, punched out of a metal sheet into a predetermined shape and then bent to be L-shaped.

The first connecting portion 37 of each connector pin 36 is at least partially embedded and fixed to the connector housing 32. Although not shown in FIG. 2, the first connecting portion 37 has a part including its rear end that is exposed in the recess 33. As shown in FIG. 1, a power supplying device 5 includes a connector 6 coupled to the connector housing 32 in the recess 33 to electrically connect the power supplying device 5 to the connector pins 36.

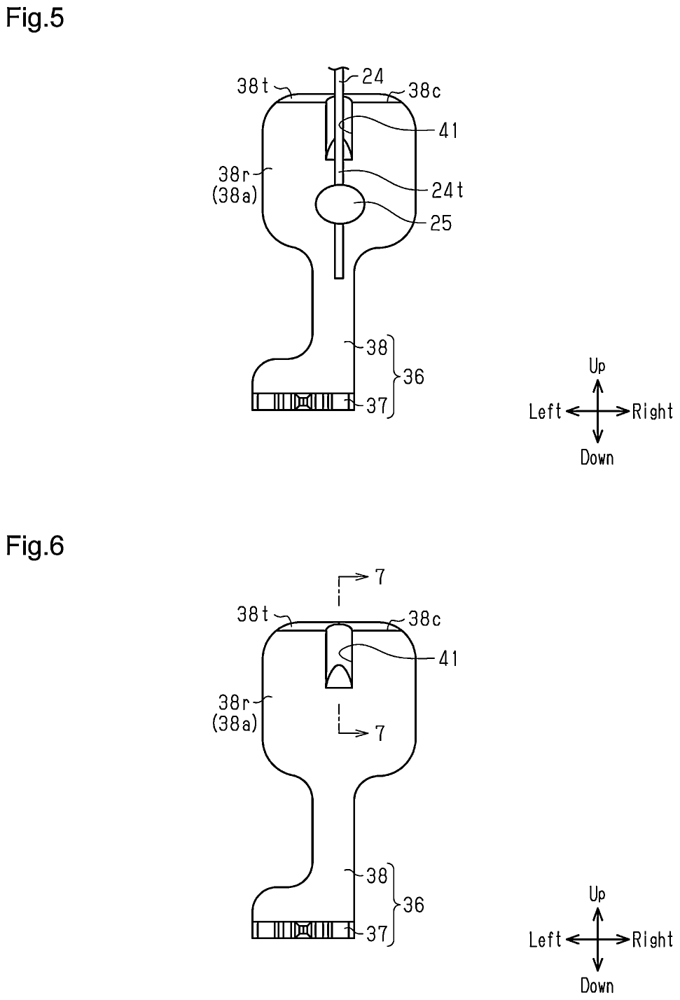

As shown in FIGS. 2 and 5, the second connecting portion 38 of each connector pin 36 is exposed to the outside of the connector housing 32. The second connecting portion 38 is in contact with the terminal 24t of the corresponding heater wire 24. Each terminal 24t is bonded to and electrically connected to the corresponding second connecting portion 38 through a bonding process such as fusing. Fusing is a process that uses electrode resistance heat to remove a coating from each terminal 24t and thermally bond the terminal 24t to the corresponding second connecting portion 38.

Structure Supporting Connector Housing 32 with Main Body 14

As shown in FIG. 2, the connector housing 32 has a front end defining a basal end 32a. The main body 14 includes a support 15 that supports the connector housing 32. The support 15 is arranged in region Z1 that extends around the connector housing 32 and includes at least the basal end 32a in the projecting direction of the connector housing 32. The support 15 is adjacent to the connector housing 32 and extends along the connector housing 32 in the projecting direction of the connector housing 32, that is, in the rearward direction.

In addition to the structure described above, the millimeter wave transmissive cover 12 includes a fastener that fastens the main body 14 and the like to the front part of the vehicle 10. The fastener may include, for example, a clip, a screw, and/or a hook.

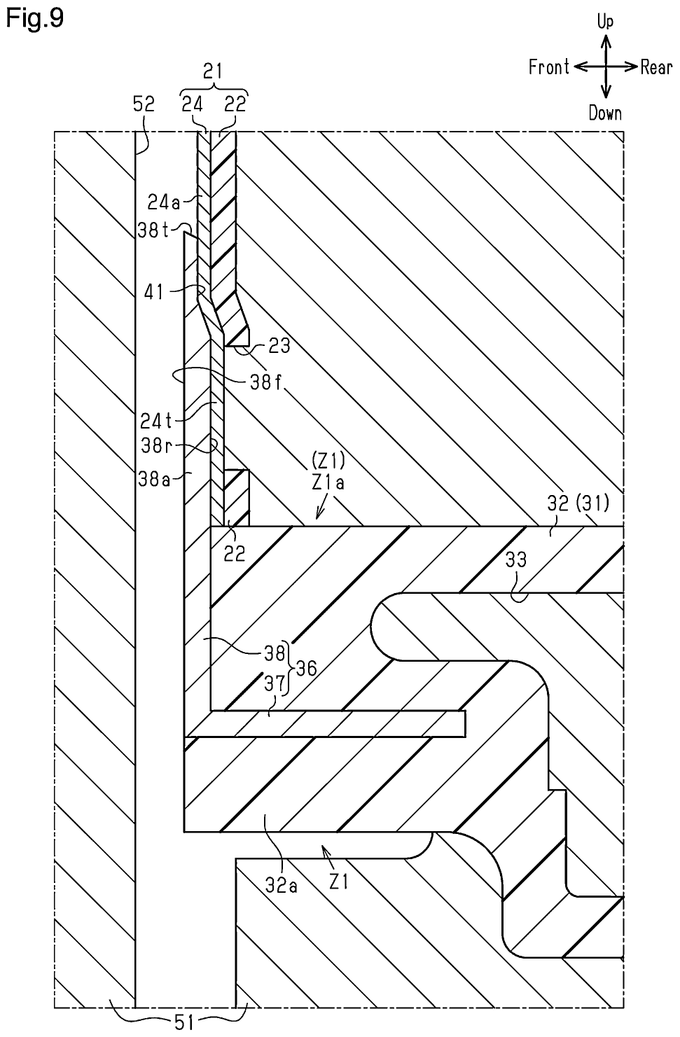

The millimeter wave transmissive cover 12 is manufactured by insert-molding the main body 14 with the connector 31 and the heater sheet 21 included as inserts (refer to FIG. 9).

The basic structure of the millimeter wave transmissive cover 12 has been described above. The features of the first embodiment will now be described.

### First Feature

As shown in FIGS. 2 and 4, the heater wire 24 includes a wiring portion 24a, which is laid out on the sheet base 22. Part of the wiring portion 24a, in the thickness direction (front-rear direction), is embedded in the sheet base 22. More specifically, 50% or greater of the heater wire 24 (wiring portion 24) in the thickness direction (front-rear direction) is embedded in the sheet base 22. The remainder of the wiring portion 24a in the thickness direction (front-rear direction) is exposed from the sheet base 22 toward the main body 14, that is, toward the front. The effect for avoiding breakage of the heater wire 24 may be improved by increasing the proportion of the part embedded in the sheet base 22. As long as the proportion of the embedded portion is at least 50%, the effect for avoiding breakage of the heater wire 24 will be sufficient.

To embed part of the wiring portion 24a in the sheet base 22 in the thickness direction, the wiring pattern of the heater wire 24 may be heated and pressed against the sheet base 22. There is no limitation to the process for embedding the wiring portion 24a and any other process may be performed to embed the wiring portion 24a.

### Second Feature

As shown in FIGS. 2 and 5, the second connecting portion 38 of each connector pin 36 includes an extension 38a. The extension 38a extends away from the connector housing 32 in a direction orthogonal to the thickness direction (front-rear direction), that is, in the orthogonal direction. In the first embodiment, the extension 38a extends upward from the connector housing 32. The vertical direction corresponds to the orthogonal direction.

The sheet base 22 and each of the terminals 24t extend to where the sheet base 22 and each of the terminals 24t is located at one side of the extension 38a in the thickness direction (front-rear direction) and the main body 14 is located an opposite side of the extension 38a in the thickness direction. This structure allows the sheet base 22 and the terminals 24t to overlap the extensions 38a in the orthogonal direction (vertical direction) as viewed in the thickness direction (front-rear direction).

The sheet base 22 and the terminals 24t each include a lower end at the side closer to the connector housing 32. The lower ends of the sheet base 22 and the terminals 24t are in contact with or proximate to the connector housing 32.

Each terminal 24t contacts a rear surface 38r of the corresponding extension 38a. The terminal 24t is bonded to and electrically connected to a relatively flat part of the extension 38a through a bonding process such as fusing, as described above.

The bonding is performed through a window 23 of the sheet base 22. A plug 25 is arranged in the window 23 to prevent the entry of water into the bonded part. The plug 25 is formed by, for example, filling the window 23 with potting material.

### Third Feature

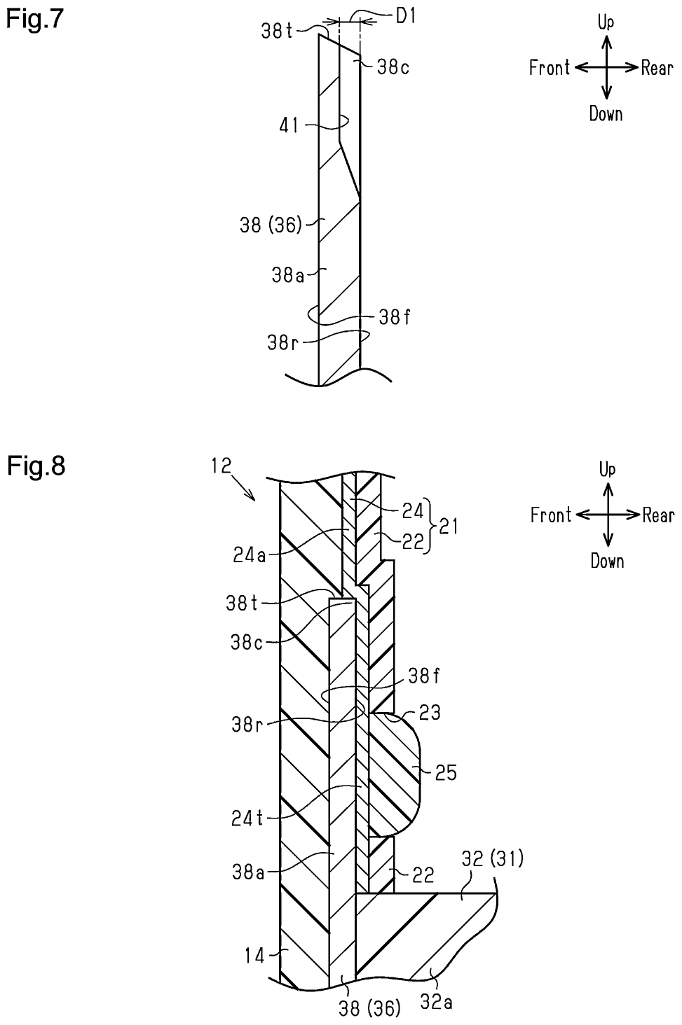

As shown in FIGS. 2 and 7, each extension 38a includes a groove 41 extending toward the first connecting portion 37 from an end surface of the extension 38a that is farther from the first connecting portion 37. The groove 41 is open in the surface of the extension 38a that is closer to the sheet base 22 in the thickness direction (front-rear direction). In the first embodiment, the groove 41 extends downward from an upper end surface 38t of the second connecting portion 38. The groove 41 is open in the rear surface 38r of the second connecting portion 38.

The groove 41 receives part of the corresponding terminal 24t. The terminal 24t contacts an upper end corner 38c of the second connecting portion 38. The upper end of the second connecting portion 38 is the end at the side farther from the corresponding first connecting portion 37. The groove 41 receives the terminal 24t at the contacting part and the section proximate to the contacting part.

### Fourth Feature

In FIGS. 4 and 7, A1 represents the dimension in the thickness direction (front-rear direction) of the part of the heater wire 24 embedded in the sheet base 22. Further, B1 represents the diameter of the heater wire 24, and D1 represents the depth of the groove 41.

Preferably, dimension A1, diameter B1, and depth D1 are set to satisfy the relationship of inequality (1).

$$A 1 + D 1 > B 1 \qquad Inequality ( 1 )$$

### Fifth Feature

As shown in FIG. 2, in region Z1 that extends around the connector housing 32, a region located at a side of the sheet base 22 opposite to the extension 38a in the thickness direction (front-rear direction) defines a sheet rear surface region Z1a. The support 15 is arranged in region Z1 at a location that differs from sheet rear surface region Z1a.

The operation of the first embodiment will now be described.

### Attachment of Millimeter Wave Transmissive Cover 12

When attaching the millimeter wave transmissive cover 12 to the vehicle 10, as shown in FIG. 1, the millimeter wave transmissive cover 12 is held upright and arranged on the front part of the vehicle 10 in front of the millimeter wave radar device 11. The millimeter wave transmissive cover 12 is attached by the fastener to the vehicle 10.

The connector 31 of the millimeter wave transmissive cover 12 is coupled to the connector 6 of the power supplying device 5. The heater wire 24 is electrically connected by the connector pins 36 to the power supplying device 5.

### Millimeter Wave Transmissive Cover 12

Millimeter waves transmitted toward the front from the millimeter wave radar device 11 pass through the transmissive part of the millimeter wave transmissive cover 12. When the millimeter waves are reflected by an object in front of the vehicle 10, such as a front vehicle or a pedestrian, the reflected millimeter waves pass through the millimeter wave transmissive cover 12 again and are received by the millimeter wave radar device 11. Based on the transmitted and received millimeter waves, the millimeter wave radar device 11 performs processes such as object recognition, calculation of distance between the object and the vehicle 10, and calculation of relative velocity.

Accumulation of snow and ice on the millimeter wave transmissive cover 12 may attenuate the millimeter waves and adversely affect the detecting performance of the millimeter wave radar device 11. In such a case, referring to FIGS. 1 and 2, electric power from the power supplying device 5 is supplied via the connector 6 of the power supplying device 5 and the connector pins 36 in the connector 31 of the millimeter wave transmissive cover 12 to the heater wire 24. This energizes the heater wire 24 and generates heat, part of which is transferred to the millimeter wave transmissive cover 12. The heat melts the snow and ice accumulated on the millimeter wave transmissive cover 12 and mitigates attenuation of the millimeter waves caused by the accumulation of snow and ice.

### Heater Wire 24 Embedded in Sheet Base 22

Arrangement of the entire wiring portion 24a on the sheet base 22 in the thickness direction may result in a defect if the connector 31 and the heater sheet 21 are insert-molded with the main body 14 when manufacturing the millimeter wave transmissive cover 12. More specifically, the flow pressure (molding pressure) of the molten plastic injected into a cavity 52 of a molding device 51 (refer to FIG. 9) may apply shear force to the heater wire 24 in a direction extending along a front surface 22f of the sheet base 22. The shear force may move the heater wire 24 along the front surface 22f and cause deformation that leads to wire breakage.

In this respect, as shown in FIGS. 4 and 9, in the first embodiment, 50% or greater of the wiring portion 24a in the thickness direction (front-rear direction) of the main body 14 is embedded in the sheet base 22. The embedded part reduces the part of the wiring portion 24a exposed (bulged) from the sheet base 22. The shear force produced by the flow pressure of the molten plastic is not directly applied to the part of the wiring portion 24a embedded in the sheet base 22. The shear force is directly applied to the part of the wiring portion 24a exposed (bulged) from the sheet base 22. The part of the heater wire 24 subject to the application of shear force is less than a case where the entire wiring portion 24a is exposed from the sheet base 22 and not supported by the sheet base 22. Thus, the shear force produced by the flow pressure of molten plastic and applied to the wiring portion 24a is less than that when the entire wiring portion 24a is exposed from the sheet base 22. Further, the part of the wiring portion 24a embedded in the sheet base 22 is held in place.

Consequently, even when shear force is applied to the bulged part in the direction extending along the front surface 22f of the sheet base 22, the shape of the wiring portion 24a will be maintained. This will avoid deformation of the wiring portion 24a caused by forced movement along the front surface 22f.

### Overlapping of Connector Pins 36 and Sheet Base 22

Separation of the extensions 38a from the sheet base 22 in the orthogonal direction (vertical direction) may result in a defect if the main body 14 is insert-molded as described above when manufacturing the millimeter wave transmissive cover 12. More specifically, the part of each terminal 24t located between the corresponding extension 38a and the sheet base 22 would not be supported by any one of the extension 38a and the sheet base 22. Thus, the application of shear force, which is produced by the flow pressure of molten plastic, to the terminal 24t may deform the terminal 24t and cause wire breakage.

In this respect, in the first embodiment, each terminal 24t overlaps the corresponding extension 38a in the vertical direction as viewed in the front-rear direction. Further, as shown in FIGS. 2 and 9, each terminal 24t is held between the corresponding extension 38a and the sheet base 22 in the thickness direction (front-rear direction). Thus, the shear force produced by the flow pressure of molten plastic is received by at least the extensions 38a. This limits the shear force that is directly applied to the terminals 24t. As a result, deformation of the terminals 24t will not occur.

### Groove 41 of Connector Pin 36

Part of each terminal 24t contacts the upper end corner 38c of the corresponding extension 38a.

This may result in a defect if the main body 14 is insert-molded when manufacturing the millimeter wave transmissive cover 12. More specifically, as shown in FIG. 8, each terminal 24t would be sandwiched from opposite sides in the thickness direction (front-rear direction) by the corresponding extension 38a and the sheet base 22. The heater sheet 21 is fixed to the molding device 51. Thus, when the flow pressure of molten plastic forces the extension 38a toward the sheet base 22, the sheet base 22 and the corner 38c of the second connecting portion 38 will apply shear force to the part of the terminal 24t contacting the corner 38c. The shear force may cause wire breakage of the terminal 24t.

In this respect, in the first embodiment, as shown in FIGS. 2 and 5, the part of the terminal 24t that contacts the corner 38c is received in the groove 41. This mitigates the shear force applied to the contacting portion. This effect is increased when dimension A1, diameter B1, and depth D1 satisfy the relationship of inequality (1).

### Shape of Support 15 on Main Body 14

Arrangement of the support 15 in sheet rear surface region Z1a as shown by the double-dashed lines in FIG. 2 may result in a defect if the main body 14 is insert-molded when manufacturing the millimeter wave transmissive cover 12. More specifically, when molten plastic flows to sheet rear surface region Z1a, the flow pressure of the molten plastic will produce shear force that is applied to the terminals 24t directly or through the sheet base 22. The shear force may deform the terminals 24t and cause wire breakage.

In this respect, in the first embodiment, as shown in FIGS. 2 and 9, the support 15 is arranged in region Z1, which extends around the connector housing 32, at a location differing from sheet rear surface region Z1a. The support 15 is not arranged in sheet rear surface region Z1a. Thus, when performing insert-molding, molten plastic will now flow in sheet rear surface region Z1a. This mitigates the shear force applied to the terminals 24t directly or through the sheet base 22 by the flow pressure of molten resin. As a result, deformation of the terminals 24t will not occur.

The advantages of the first embodiment will now be described.
(1-1) In the first embodiment, as shown in FIG. 4, 50% or greater of the heater wire 24 (wiring portion 24a) in the thickness direction (front-rear direction) is embedded in the sheet base 22.

This mitigates the shear force applied to the wiring portion 24a by the flow pressure of molten resin when molding the main body 14 from plastic. Thus, wire breakage of the wiring portion 24a is avoided.
(1-2) In the first embodiment, as shown in FIG. 2, each second connecting portion 38 includes the extension 38a. Part of the sheet base 22 and the corresponding terminal 24t overlaps the extension 38a in the orthogonal direction (vertical direction) as viewed in the thickness direction (front-rear direction). The terminal 24t is sandwiched from opposite sides in the thickness direction (front-rear direction) by the extension 38a and the sheet base 22.

Thus, when molding the main body 14 from plastic, the flow pressure of molten resin is received by at least the extension 38a. This limits the shear force applied to the terminal 24t by the flow pressure of molten resin. Thus, wire breakage of the terminal 24t is avoided.
(1-3) In the first embodiment, as shown in FIGS. 6 and 7, each extension 38a includes the groove 41 that is open in the rear surface 38r and extends in the lower direction from the upper end surface 38t of the second connecting portion 38 toward the first connecting portion 37.

Thus, when insert-molding the main body 14, even if the flow pressure of molten plastic forces each extension 38a toward the sheet base 22 in the rear direction, the shear force applied by the corner 38c and the sheet base 22 to the terminal 24t will be mitigated. This avoids wire breakage of the terminal 24t.
(1-4) In the first embodiment, as shown in FIGS. 4 and 7, the sum of dimension A1 of the embedded part of the heater wire 24 and depth D1 of the groove 41 is greater than diameter B1 of the heater wire 24.

This mitigates the shear force applied from the extensions 38a and the sheet base 22 to the terminals 24t. The groove 41 greatly contributes to avoiding wire breakage of the terminals 24t.
(1-5) In the first embodiment, as shown in FIG. 2, the support 15, which supports the connector housing 32, is arranged in region Z1, which extends around the connector housing 32, at a location that differs from sheet rear surface region Z1a. This mitigates the shear force applied to the terminals 24t directly or through the sheet base 22 by the flow pressure of molten resin when insert-molding the main body 14. Thus, wire breakage of the terminal 24t that would be caused by the shear force is avoided.
(1-6) In the first embodiment, each terminal 24t is bonded to the corresponding extension 38a at a location separated from the groove 41, that is, a location having less irregularities than the groove 41. This facilitates the bonding process when fusing the terminal 24t to the projection 38a.

### Second Embodiment

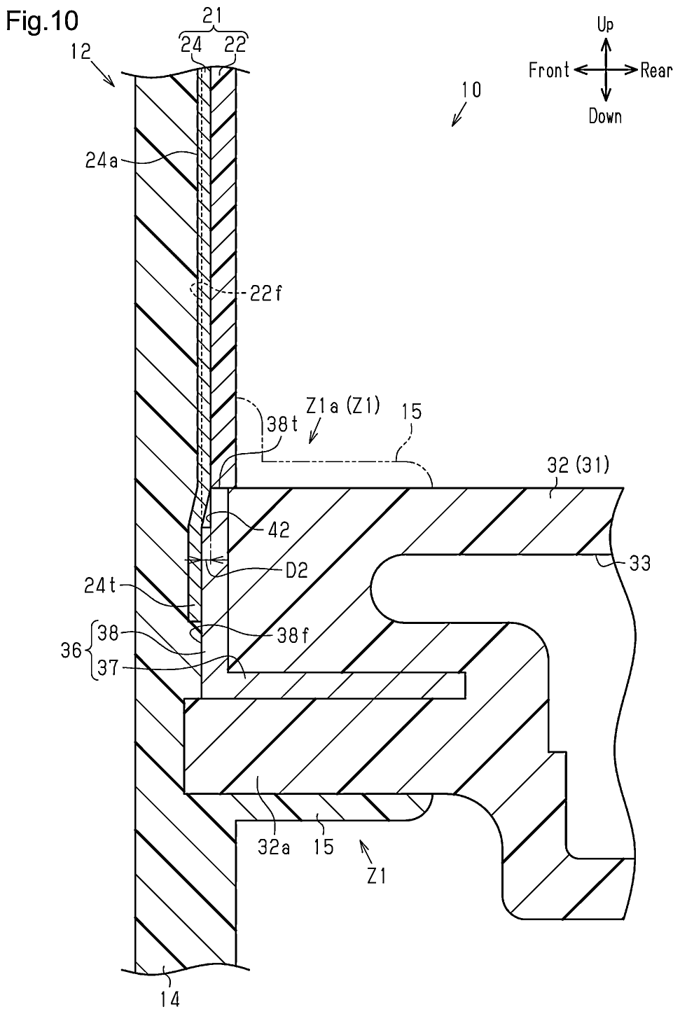

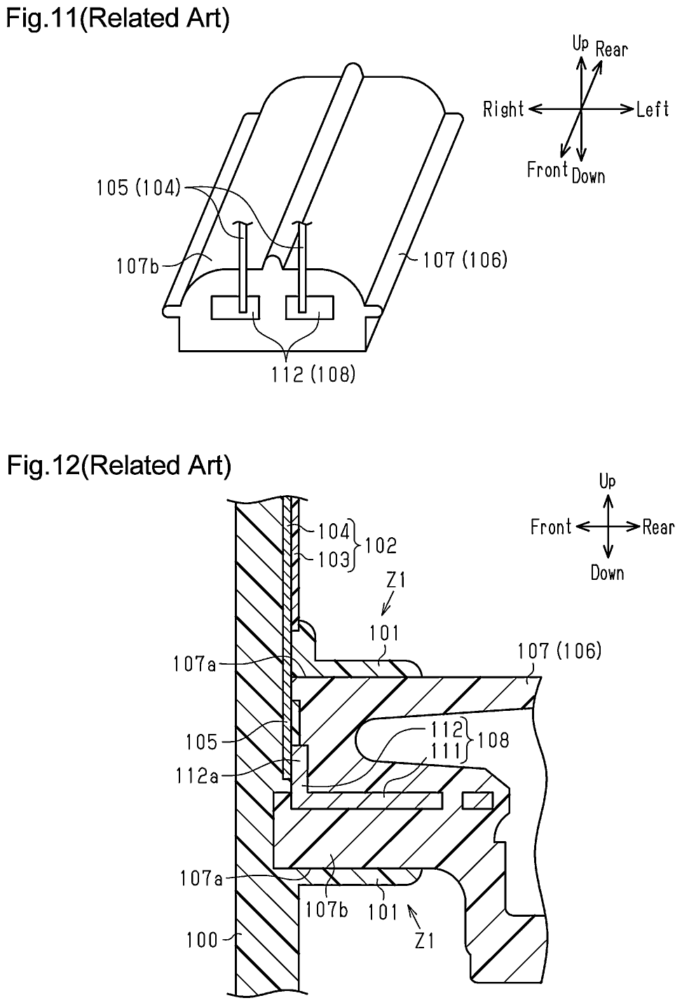

A millimeter wave transmission cover, which is a second embodiment of a vehicle exterior transmissive cover, will now be described with reference to FIG. 10.

In the second embodiment, the positional relationship of each second connecting portion 38 and the sheet base 22 differs from that of the first embodiment. More specifically, each second connecting portion 38 does not include the extension 38a. Thus, the second embodiment does not have the second feature of the first embodiment. The second connecting portion 38 includes a front surface 38f that is the surface at the side closer to the main body 14 in the thickness direction (front-rear direction). The surface of the sheet base 22 at the side closer to the main body 14 is the front surface 22f. The front surface 38f is adjacent to and flush with the front surface 22f in a direction orthogonal to the thickness direction.

Thus, the second embodiment differs from the first embodiment in that part of the sheet base 22 does not overlap each second connecting portion 38 in the orthogonal direction (vertical direction) of the main body 14 as viewed in the thickness direction (front-rear direction).

In the second embodiment, the part of the heater wire 24 excluding the terminals 24t (part above two terminals 24t) corresponds to the wiring portion 24a of the first embodiment. The second embodiment has the first feature of the first embodiment. That is, 50% or greater of the wiring portion 24a in the thickness direction (front-rear direction) is embedded in the sheet base 22.

Each terminal 24t extends from the sheet base 22 toward the corresponding first connecting portion 37 in the lower direction in a state contacting the front surface 38f of the second connecting portion 38, which is the surface at the side closer to the main body 14 in the thickness direction (front-rear direction). Each terminal 24t is bonded to the corresponding second connecting portion 38 in the same manner as the first embodiment. The terminal 24t is electrically connected to the second connecting portion 38 at least at the bonded part.

Each second connecting portion 38 includes a groove 42. The groove 42 extends from the upper end surface 38t, which is at the side farther from the first connecting portion 37. The groove 42 extends toward the first connecting portion 37 in the lower direction and is open in the front surface 38f, which is the surface closer to the main body 14 in the thickness direction (front-rear direction).

The groove 42 receives the terminal 24t at the part contacting the upper end corner 38c of the second connecting portion 38 and the section proximate to the contacting part.

In the same manner as the first embodiment, A1 represents the dimension in the thickness direction of the part of the heater wire 24 embedded in the sheet base 22. Further, D2 represents the depth of the groove 42. Instead of the fourth feature of the first embodiment, preferably, dimension A1 and depth D2 are set to satisfy the relationship of inequality (2).

$$D 2 > A 1 \qquad Inequality ( 2 )$$

Otherwise, the structure of the second embodiment is the same as the first embodiment. Thus, like or the same reference numerals are given to those components that are the same as the corresponding components of the first embodiment. Such components will not be described in detail. The structure corresponding to the fifth feature of the first embodiment may be included or omitted from the second embodiment.

The operation of the second embodiment will now be described focusing on differences from the first embodiment.

### Groove 42 of Connector Pin 36

Part of the wiring portion 24a, in the thickness direction (front-rear direction), is embedded in the sheet base 22. In contrast, each terminal 24t is entirely arranged on the front surface 38f of the corresponding second connecting portion 38. The terminal 24t extends out of the sheet base 22 onto the front surface 38f.

The wiring portion 24a is the part of the heater wire 24 embedded in the sheet base 22. The terminals 24t is the part of the heater wire 24 arranged on the front surface 38f of each second connecting portion 38. The wiring portion 24a is located at a position in the thickness direction (front-rear direction) that differs from the position where the terminals 24t are located in the thickness direction. Part of each terminal 24t contacts the upper end corner 38c of the second connecting portion 38. At the part bounding each second connecting portion 38 and the sheet base 22, the terminals 24t are inclined with respect to the front surfaces 38f and 22f, which are flush with each other.

The corner 38c of each second connecting portion 38 may apply shear force to the part of the corresponding terminal 24t that is in contact with the corner 38c and cause wire breakage of the terminal 24t.

In this respect, in the second embodiment, the groove 42 receives the part of the corresponding terminal 24t contacting the corner 38c and the section proximate to the contacting part. Thus, the inclination of the terminals 24t with respect to the front surfaces 38f and 22f, which are flush with each other, can be gradual at the part bounding each second connecting portion 38 and the sheet base 22. This mitigate the shearing force applied to each terminal 24t and avoids wire breakage. This effect is increased when dimension A1 and depth D2 satisfy the relationship of inequality (2).

Accordingly, the second embodiment has advantage (1-1) corresponding to the first feature of the first embodiment. The second embodiment also has advantage (2-3), which corresponds to the third feature, and advantage (2-4), which corresponds to the fourth feature.
(2-3) In the millimeter wave transmissive cover 12 of the second embodiment, the front surface 38f of each second connecting portion 38 is adjacent to and flush with the front surface 22f of the sheet base 22. Each terminal 24t is electrically connected to the corresponding second connecting portion 38 and extends downward from the sheet base 22 in a state contacting the front surface 38f of the corresponding second connecting portion 38.

The second connecting portion 38 includes the groove 42 that extends in the lower direction from the upper end surface 38t of the first connecting portion 37 toward the first connecting portion 37. The groove 42 is open in the front surface 38f, which is the surface of the second connecting portion 38 that is closer to the main body 14 in the thickness direction.

This mitigates the shear force applied from the corner 38c of the second connecting portion 38 to the part of the terminal 24t contacting the corner 38c. Thus, wire breakage of the terminal 24t is avoided.
(2-4) In the second embodiment, the depth D2 of the groove 42 is greater than dimension A1 of the embedded part of the heater wire 24 in the thickness direction.

This mitigates the shear force applied to the part of the terminal 24t contacting the corner 38c in the end of the corresponding connecting portion 38. Thus, wire breakage of the terminal 24t is avoided. The groove 42 greatly contributes to avoiding wire breakage of the terminals 24t.

The above embodiments may be modified as described below. The above embodiment and the modified examples described below may be combined as long as there is no technical contradiction.

### Heater Sheet 21

In the first embodiment, the lower ends of the sheet base 22 and the heater wire 24 may be in contact with the connector housing 32 or separated from the connector housing 32 in the orthogonal direction (vertical direction).

In the first and second embodiments, the sheet base 22 of the heater sheet 21 may be arranged on the front side of the main body 14. In this case, preferably, the sheet base 22 is formed from a transparent plastic such as PC.

In the first and second embodiments, the terminals 24t of the heater wire 24 may be bonded to the connector pins 36 in the grooves 41 and 42.

In the first and second embodiments, the terminals 24t of the heater wire 24 may be bonded to the connector pins 36 through a process other than fusing. Examples of such bonding processes include soldering and crimping.

In the first and second embodiments, the heater sheet 21 may have more than one heater wire 24.

In the first embodiment, less than 50% of the heater wire 24 in the thickness direction may be embedded in the sheet base 22. Further, the entire heater wire 24 in the thickness direction may be exposed from the sheet base 22. In such a case, advantage (1-1) will not be obtained or be difficult to obtain. Nevertheless, advantages (1-2) to (1-5) will be obtained. Thus, wire breakage of the heater wire 24 can be avoided.

### Connector 31

In the first embodiment, when dimension A1, diameter B1, and depth D1 satisfy the relationship of inequality (1), the groove 41 will greatly contribute to avoiding wire breakage of the terminals 24t. Depth D1 of the groove 41 may, however, be less than a value that satisfies inequality (1). Even in this case, wire breakage can be avoided.

In the second embodiment, when dimension A1 and depth D2 satisfy the relationship of inequality (2), the groove 42 will greatly contribute to avoiding wire breakage of the terminals 24t. Depth D2 of the groove 42 may, however, be less than a value that satisfies inequality (2). Even in this case, wire breakage can be avoided.

The connector 31 may be arranged on the millimeter wave transmissive cover 12 at a position differing from that of the first and second embodiments. In the first and second embodiments, the connector 31 is located at the lower side of the heater sheet 21 but may be located at the upper side, right side, or left side of the connector 31.

In the first and second embodiments, the corner 38c in the end of each second connecting portion 38 at the side farther from the first connecting portion 37 may be chamfered at least at the part that contacts the corresponding terminal 24t. In this case, in the same manner as the grooves 41 and 42, the shear force applied by the corner 38c of each second connecting portion 38 and the sheet base 22 to the corresponding terminals 24t will be mitigated. Thus, wire breakage of the heater wire 24 can be avoided.

### Others

The main body 14 may be used for ornamental purposes of the vehicle 10, but it is not required to be used for ornamental purposes.

In the first embodiment, as long as 50% or greater of the wiring portion 24a is embedded in the sheet base 22, the structure corresponding to any of the second, third, and fifth features may be omitted.

Any vehicle exterior component may be used that is transmissive to electromagnetic waves and incorporated in a vehicle including a sensor device that detects an object outside the vehicle by transmitting and receiving electromagnetic waves. In this case, in addition to millimeter waves, the electromagnetic waves transmitted and received by the sensor device may be infrared waves or the like.

In addition to being used for forward monitoring, the sensor device that detects an object outside the vehicle by transmitting and receiving electromagnetic waves may be used for rear monitoring, front right and left monitoring, and rear right and left monitoring. In this case, the vehicle exterior component is arranged in front of the sensor device with respect to the transmission direction of the electromagnetic waves.

The vehicle exterior component may be incorporated in a vehicle that does not include a sensor device for detecting an object outside the vehicle by transmitting and receiving electromagnetic waves. In this case, the vehicle exterior component may be applied to any component used for ornamental purposes of a vehicle, such as an emblem, an ornament, a mark, and/or the like.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle exterior component, comprising:
a main body that is plate-shaped and formed by a plastic molded article; and
a heater sheet and a connector that are arranged on the main body, wherein
the heater sheet includes a sheet base arranged on the main body, and a heater wire configured to be heated when energized and including two ends defining two terminals,
the heater wire includes a part excluding the two terminals that is laid out on the sheet base at a side closer to the main body,
the connector includes a connector housing fixed to the main body, and two connector pins fixed to the connector housing,
each of the connector pins includes a first connecting portion configured to be coupled to a power supplying device, and a second connecting portion electrically connected to a corresponding one of the terminals of the heater wire outside the connector housing, and
the heater wire includes a part that is laid out on the sheet base so that 50% or greater of the heater wire in a thickness direction of the main body is embedded in the sheet base.

2. The vehicle exterior component according to claim 1, wherein
the second connecting portion of each of the connector pins includes an extension that extends away from the connector housing in a direction orthogonal to the thickness direction, and
the sheet base and each of the terminals extend to where the sheet base and each of the terminals are located at one side of the extension in the thickness direction and the main body is located at an opposite side of the extension.

3. The vehicle exterior component according to claim 2, wherein the extension of each of the connector pins includes a groove extending toward the first connecting portion from an end surface of the extension that is farther from the first connecting portion, the groove being open in a surface of the extension that is closer to the sheet member in the thickness direction.

4. The vehicle exterior component according to claim 3, wherein
the heater wire has a circular cross section, and
when A1 represents a dimension in the thickness direction of a part of the heater wire embedded in the sheet base, B1 represents a diameter of the heater wire, and D1 represents a depth of the groove, A1, B1, and D1 are set to values satisfying the relationship of A1+D1>B1.

5. The vehicle exterior component according to claim 2, wherein
the connector housing projects from the main body toward one side in the thickness direction,
when an end of the connector housing at the side closer to the main body defines a basal end, the main body includes a support that supports the connector housing in part of a region that extends around the connector housing and includes at least the basal end in a projecting direction of the connector housing, and
in the region that extends around the connector housing, when a region located at a side of the sheet base opposite to the extensions of the connector pins in the thickness direction defines a sheet rear surface region, the support is located in the region that extends around the connector housing at a location that differs from the sheet rear surface region.

6. The vehicle exterior component according to claim 1, wherein
a surface of the second connecting portion of each of the connector pins at a side closer to the main body in the thickness direction and a surface of the sheet base at a side closer to the main body in the thickness direction are adjacent to and flush with each other in a direction orthogonal to the thickness direction,
each of the terminals is electrically connected to the second connecting portion of the corresponding connector pin and extends from the sheet base toward the first connecting portion of the corresponding connector pin in a state contacting the surface of the second connecting portion that is closer to the main body in the thickness direction, and
the second connecting portion of each of the connector pins includes a groove extending toward the first connecting portion from an end surface of the second connecting portion that is farther from the first connecting portion, the groove being open in the surface of the second connecting portion that is closer to the main body in the thickness direction.

7. The vehicle exterior component according to claim 6, wherein
the heater wire has a circular cross section, and
when A1 represents a dimension in the thickness direction of a part of the heater wire embedded in the sheet base, and D2 represents a depth of the groove, A1 and D2 are set to values satisfying the relationship of D2>A1.

8. A vehicle exterior component, comprising:
a main body that is plate-shaped and formed by a plastic molded article; and
a heater sheet and a connector that are arranged on the main body, wherein
the heater sheet includes a sheet base arranged on the main body, and a heater wire configured to be heated when energized and including two ends defining two terminals,
the heater wire includes a part excluding the two terminals that is laid out on the sheet base at a side closer to the main body,
the connector includes a connector housing fixed to the main body, and two connector pins fixed to the connector housing,
each of the connector pins includes a first connecting portion configured to be coupled to a power supplying device, and a second connecting portion electrically connected to a corresponding one of the terminals of the heater wire outside the connector housing,
the second connecting portion of each of the connector pins includes an extension that extends away from the connector housing in a direction orthogonal to the thickness direction,
the sheet base and each of the terminals extend to where the main body is located at an opposite side of the extension in the thickness direction, and
the extension of each of the connector pins includes a groove extending toward the first connecting portion from an end surface of the extension that is farther from the first connecting portion, the groove being open in a surface of the extension that is closer to the sheet member in the thickness direction.
